(19) United States
(12) Patent Application Publication
(10) Pub. No.: US 2002/0192623 A1
(43) Pub. Date: Dec. 19, 2002

(54) Method and apparatus for delivering educational training and assessment via the internet

(76) Inventors: Brad Sather, Boulder, CO (US); Scott Shaver, Lakewood, CO (US); John Molfese, Boulder, CO (US)

Correspondence Address: GIBSON, DUNN & CRUTCHER LLP, 1801 California Street, Suite 4100, Denver, CO, 80202-2641, US

(21) Appl. No.: 09/882,373

(22) Filed: Jun. 15, 2001

(51) Int. Cl. H01H 73/00

(52) U.S. Cl. 434/118

(57) ABSTRACT

A method for providing “hands-on” training on a client-server network includes the steps of using a client to specify an address of an executable program located on a server, the executable program including a simulation of a physical object that can be manipulated by a user and the executable program having a monitoring capability for monitoring the user's inputs to the client while the user is manipulating the simulated object, downloading the executable program from the server to run on the client so as to run the simulation and track the user's inputs to the client, uploading the user's input data acquired by the executable program to the server. The monitored user input data is stored in a database in a server for use in analysis and assessment of the user's proficiency at manipulating the simulated object.

### FIELD OF THE INVENTION

The present invention relates to a method and apparatus for delivering educational information, simulations, training, testing and assessment via the Internet.

### BACKGROUND OF THE INVENTION AND PRIOR ART

The advent and acceptance of the Internet and the World Wide Web has created an opportunity for businesses and institutions to deliver education and training programs remotely. That is, rather than bringing people into a classroom to receive instruction from a live teacher, instructional materials can now be delivered anywhere that people have access to the Internet. Instructional material is typically delivered over the Internet in the form of a web page, that web page usually having a combination of static graphics, text, and links to other web pages. A given course of study typically includes many such web pages, all linked together in sequence. Such a course may also include testing of the student, usually involving one or more web pages containing test questions of the multiple-choice variety that the student is required to answer. Instructional programs delivered through the Internet have many advantages over live instruction. For example, they can be delivered at any time of day, virtually anywhere in the world. Cost per student can be a fraction of what live instruction costs.

While such online courses are well suited for material that students can master through passive observation (that is, by reading text or viewing graphical information), they have not been very effective for courses where “hands-on” practice is needed for mastery. For example, learning many medical procedures requires hands-on practice. Likewise, a student's mastery of such a procedure cannot effectively be assessed through a set of multiple-choice questions, but rather must be tested in some type of hands-on environment.

Delivering effective hands-on training and assessment over the Internet requires the following:

1. Delivery of a realistic representation of the equipment or physical entity that is to be manipulated by the student.

2. Monitoring of the student's interaction with the computer and the simulated physical entity.

3. Storing and/or analyzing the monitored data to determine how well the student performed the simulated hands-on procedure.

4. During the training and/or practice phases, communicating the results of that analysis to the student as feedback.

5. During the assessment phase, communicating the student's performance to a teacher or other assessing entity.

The delivery of high-quality hands-on training and assessment over the Internet has been limited primarily by the difficulty of creating realistic, manipulatable representations of physical entities that can be delivered on a web page, and by the commercially available web browsing software that provides essentially no tracking of user input. For example, Internet browsing software such as Microsoft Internet Explorer and Netscape Navigator have no built-in capability to capture or communicate a user's interactions with a given web page. These browser programs do not keep track of things such as the time spent moving the mouse, time between clicks, mouse drag events, etc. Thus using the existing tracking capabilities built into commercially available browsers, the hands-on training would be limited to exercises where one simply clicks a series of links on the web page in sequence.

U.S. Pat. No. 5,796,592 by Davies, et al, describes a method whereby a tracking program is downloaded from a server for the purposes of monitoring a user's input and interactions with a web page. The purpose of the Davies method was to automatically collect information regarding a user's preferences and to thereby build a profile of that user. That profile could then be used to create customized information or web pages specifically tailored to that user's preferences. Such personal profiles could be of great value to online retailers and other e-commerce businesses as a means to fine-tune their promotional and advertising materials. The Davies patent does not, however, discuss the use of such a method incorporated within a training simulation whereby tracking of the student's input would allow the student to perform a simulated procedure with a simulated object. Likewise it does not discuss utilizing that tracked student input for the purpose of training feedback or assessment of the student's proficiency at performing a simulated procedure.

In view of the foregoing shortcomings of the prior art, an object of the present invention is to provide a method and apparatus for providing a web page having an imbedded resource that generates and displays a manipulatable representation of a physical entity.

A further object of the present invention is to include in the imbedded resource the ability to track user interaction with the represented physical entity.

Another object of the present invention is to communicate the tracked data from the user's computer to a server computer connected to the network for storage and analysis of the tracked data.

Yet another object of the present invention is to create a database of user interaction data for the purpose of determining the user's ability to successfully manipulate the simulated physical entity.

Another object of the present invention is to communicate the user's performance information to the user as feedback to help the user learn to manipulate the represented physical entity.

Another object of the present invention is to communicate the user's performance information to an assessing entity for assessment purposes.

Yet another object of the present invention is to utilize a user's performance information to adaptively determine the content of subsequent web pages and training exercises in order to help the user gain proficiency in areas of demonstrated weakness.

Yet another object of the present invention is to utilize the user interaction data for the purpose of refining the design of the web page and the training simulation to improve the overall effectiveness of the training program.

### SUMMARY OF THE INVENTION

In order to achieve the above-described objects, a training program is downloaded from a server to a client. The training program itself provides three primary functions. First, it enables the display and manipulation of a representation of an object on the screen of the client computer. Second, it monitors essentially all user input and interaction with the represented on-screen object, including all mouse movements, mouse click, mouse-drags and keyboard input. And third, it communicates with a concurrently running program on the server computer for the purpose of communicating all or part of the tracked user input data. The training program commences on the client after the program is downloaded from the server and any required initialization occurs.

While monitoring the user's interaction with the represented physical entity, the training program periodically uploads the information acquired from the client to the server for storage and analysis. The data may be uploaded continuously, although preferably at predetermined intervals or events—such as when the user terminates the training program.

The uploaded data is preferably stored on the server and used to create a user transcript file. The transcript file may include data on which tasks were started and/or completed and when, how many times each task was attempted, how long each attempt took and a summary of task performance (i.e., a “grade” on the task). The transcript file may also be used to determine what subsequent task should be delivered to the user. For example, if the user failed a particular task, then the subsequent task could be a remedial one to further develop the skills that were not successfully demonstrated in the previous task. On the other hand, if the user successfully completed a particular task, the subsequent task could be a completely new one, or the user may be informed that he or she has successfully completed the training course.

The user transcript file may also be used to help the course designers refine their web pages and/or simulations to more effectively teach the subject material. For example, the tracked user data may show that many students consistently click on an area of the simulated object that does not do anything. This would indicate that a change in the simulation is needed to either reduce the tendency of users to click in that area of the simulation, or else have the simulation do something if it is clicked in that area.

In the preferred embodiment, the training program is implemented in a network based upon the client/server model, specifically the Internet or World Wide Web.

In the preferred embodiment of the present invention, the training program is embedded in an HTML document (e.g., a web page). The client uses a TCP/IP connection to request the HTML document. After the HTML document is retrieved, the client retrieves the training program. The training program is then downloaded to the client, and, after performing any required initialization; the training program displays a simulated physical object with which the user can interact. The appropriate instructions for manipulating the simulated object are also provided and describe the task that is to be performed by the user. The task may either be a practice one, where the user is still learning to successfully manipulate the onscreen object, or the task may be an actual test of the user's proficiency at manipulating the onscreen object. At this time the training program begins to track all (or some predetermined subset of) the user's interactions with the simulated object. At predetermined time intervals, every two seconds for example, the training program communicates the tracked user data with a concurrently running server application (e.g., a JAVA “servlet”) on the server. That data is then written to a user transcript database on the server.

### BRIEF DESCRIPTION OF THE DRAWINGS

FIG. 1 illustrates a computer network in which the present invention may be implemented;

FIG. 2 is a flowchart diagram of the preferred embodiment of the present invention, which is a method for delivering a training simulation and assessment program to a client computer.

### DETAILED DESCRIPTION OF THE PREFERRED EMBODIMENTS

While the present invention is described herein as being a means of delivering training via the Internet, it should be understood that this is not meant to limit its applicability. Those of ordinary skill in the art will appreciate that the present invention would have equal applicability to direct on-line connections, local area networks of all types, wide area networks, private networks, on-line subscription services, on-line database services, private networks, as well as public networks such as the Internet and the World Wide Web.

The principles underlying the Internet and the World Wide Web are described in some detail hereinbelow in connection with various aspects of the present invention, however this discussion is provided for descriptive purposes only and is not intended to imply any limiting aspects to the broadly claimed methods and systems of the present invention.

In the following discussions, the term “client” refers to a client computer (or machine) on a network, or to a process, such as a Web browser, which runs on a client computer. The term “user” refers to one or more persons that use a particular client machine.

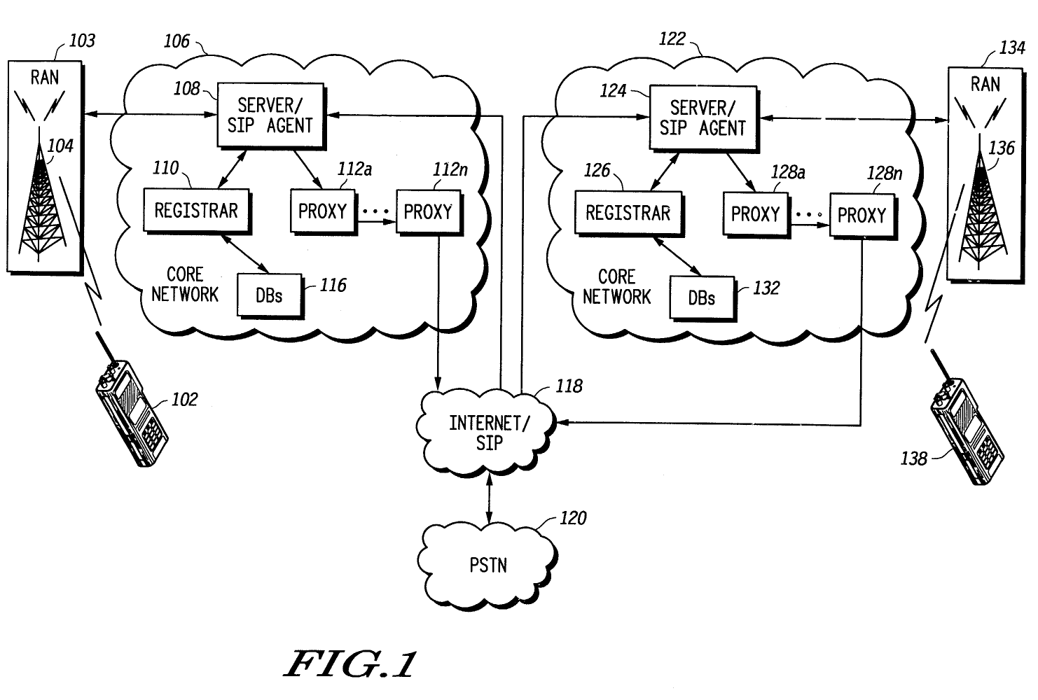

FIG. 1 is a schematic diagram of a computer network based on the client-server model, such as the Internet. The network consists of one or more “servers” 20 which are accessible by “clients” 22, such as personal computers. On the Internet, connections between servers 20 and clients 22 may be provided by a private access provider 24 or an on-line service provider 26 (such as AOL, Earthlink, the Microsoft Network, and the like). Each of the clients 22 computers may run a “Web browser”, which are known software programs used to access web sites via the client-server connection. The servers provide the clients with access to various network resources. On the Internet, for example, a server 20 provides the client with access to so-called “web sites” which comprise resources in various formats. The location of a resource on a server is identified by a so-called Uniform Resource Locator, or URL.

The “World Wide Web” (“Web”) is the array of servers on the Internet that utilize the Hypertext Transfer Protocol (HTTP). HTTP is a protocol that provides users access to resources (which can be information in different formats such as text, graphics, images, sound, video, Hypertext Markup Language—“HTML” etc., as well as programs). HTML is a page description language that provides document formatting and allows the inclusion of “links” to other servers and files. Links are specified utilizing a Uniform Resource Locator or “URL”. To utilize such a link, the client makes a TCP/IP request to the server and receives information that was specified in that URL (for example another web page) in return. In addition to “links” that a user may activate(e.g. “click on”), a typical Web page is an HTML formatted file with text and embedded URLs pointing to other resources (such as images, video or sound) that the client must retrieve from a server in order to render the Web Page in a browser. These other resources may be located on different servers than the one from which the HTML document was sent. HTTP also allows for the transmission of some information from the client to a server. This client-to-server information can be embedded within the URL, can be contained in the HTTP header fields, or can be posted directly to the server using known HTTP methods.

In the preferred embodiment of the present invention, a training program is embedded in a resource, such as an HTML document that is sent to a client from a server based on a TCP/IP request. The training program may reside on a different server than the resource, in which case it is obtained by the client through a TCP/IP request to the other server. The training program executes on a client machine once it has been downloaded from the server and stored, for example, in RAM. The training program performs three basic functions: First, it generates and displays a realistic representation of a physical object that can be manipulated by the user using the keyboard, mouse or other input device. Second, it tracks and stores that input from the user and his or her input devices. And third, it communicates with a server computer so that the tracked and stored user input can be continuously or intermittently uploaded to the server through the network (e.g., web).

In some cases, resources obtained over the network will be “cached” by clients (that is, a copy of the resource is temporarily stored on the user's computer), and the cached copy of the resource may be used instead of obtaining it over the Internet when the resource is needed at a later time (for example, in order to completely render a Web page). Operation of the training program is unchanged, regardless of whether a cached copy is used or not.

As noted above, the client uses a TCP/IP connection to pass a request to a Web server running an HTTP service. The HTTP service responds to the request typically by sending a Web page formatted in HTML to the browser. The browser then displays the Web page using local resources (e.g., fonts and colors). The training program is embedded in the Web page and is downloaded to the client along with the Web page. The training program begins operating after any required initialization has occurred.

In its basic form, the training program has three functions: deliver a simulation of a physical object to the user, monitor user input related to manipulation of the simulated object and communicate the monitored user input data to a server. The training program is linked to an HTML document and is downloaded to a client when that HTML document is served to the client in response to a client TCP/IP request. During or after the client formats and displays the Web page specified by the HTML document, the training program executes and begins displaying the simulated physical entity, monitoring user input and communicating it to another computer (server) on the Internet for storage and analysis of the monitored user input.

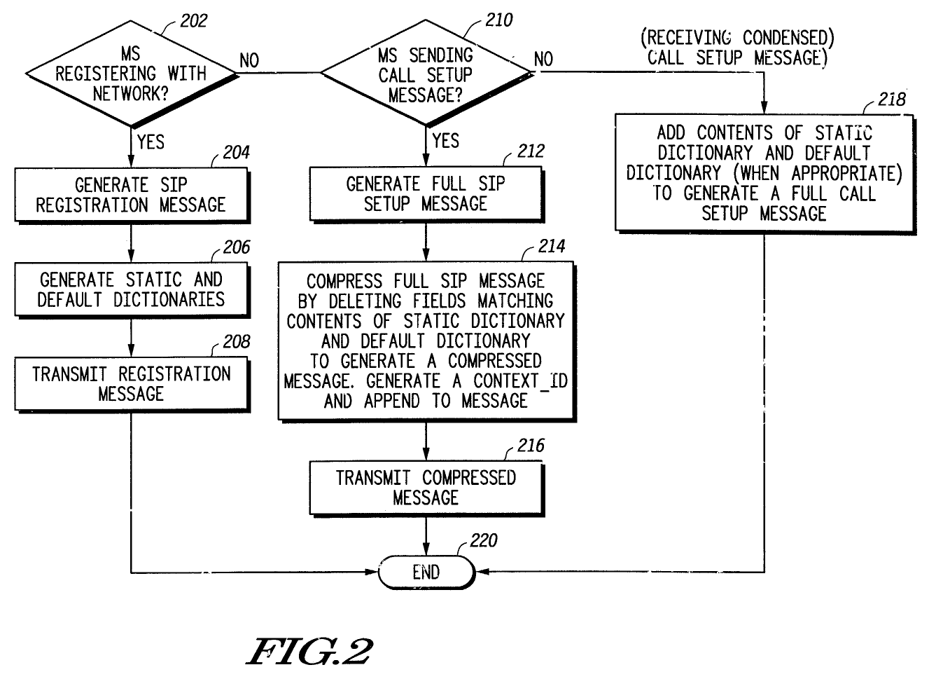

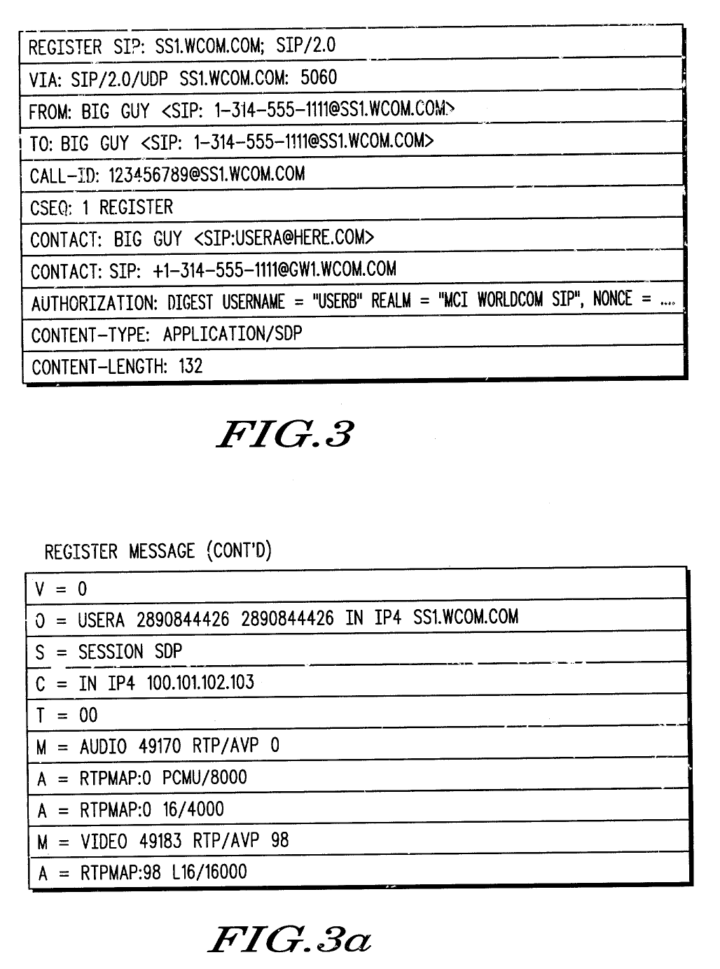

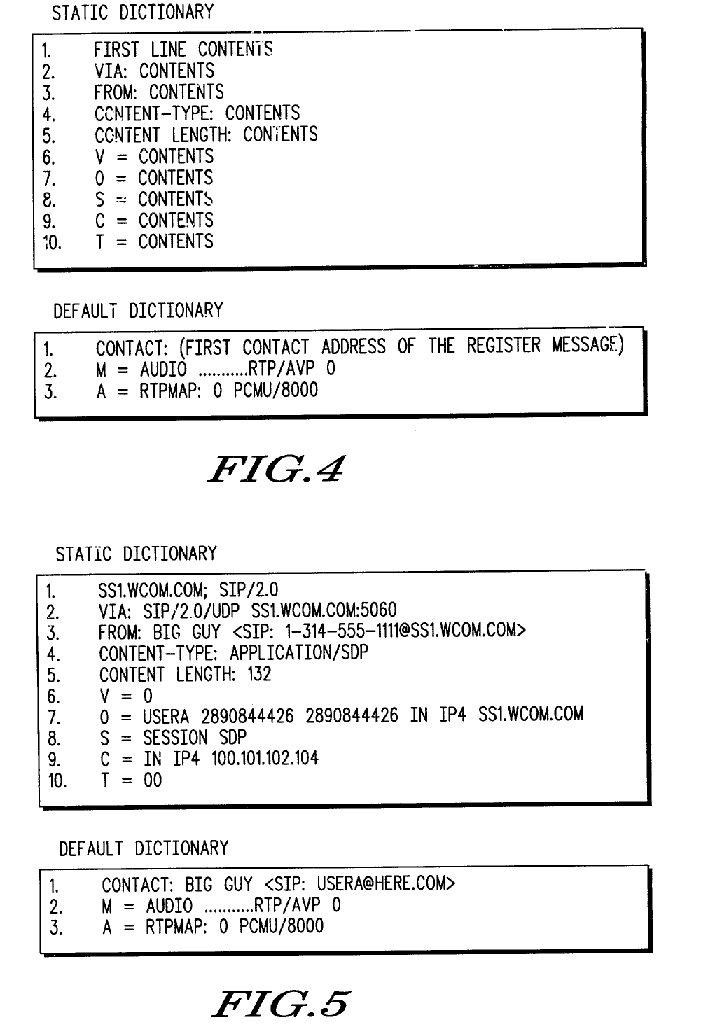

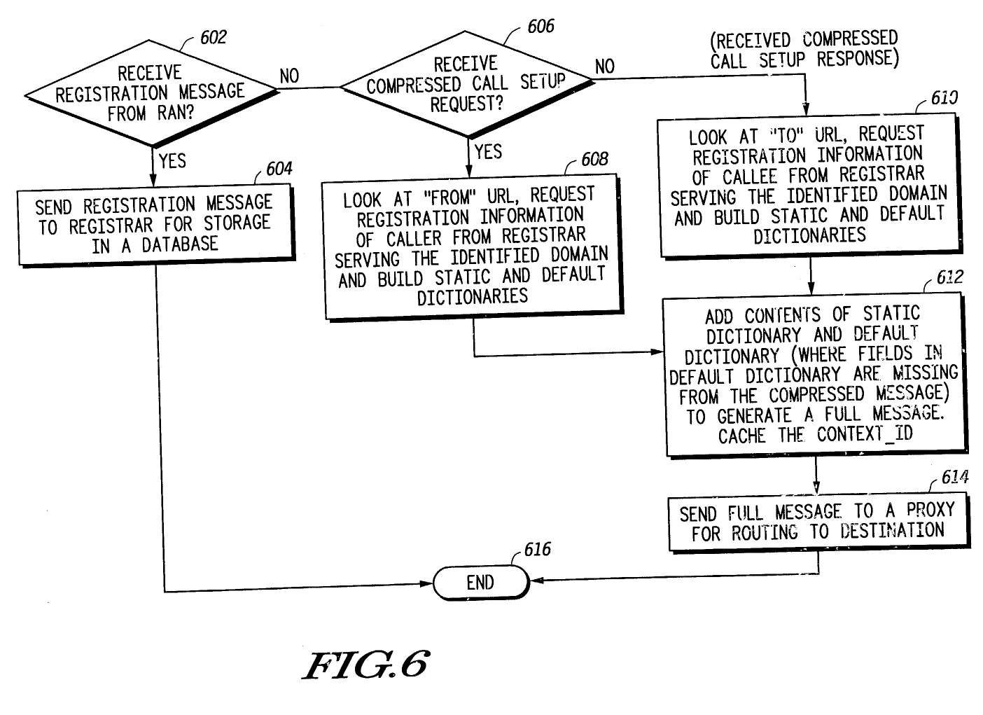

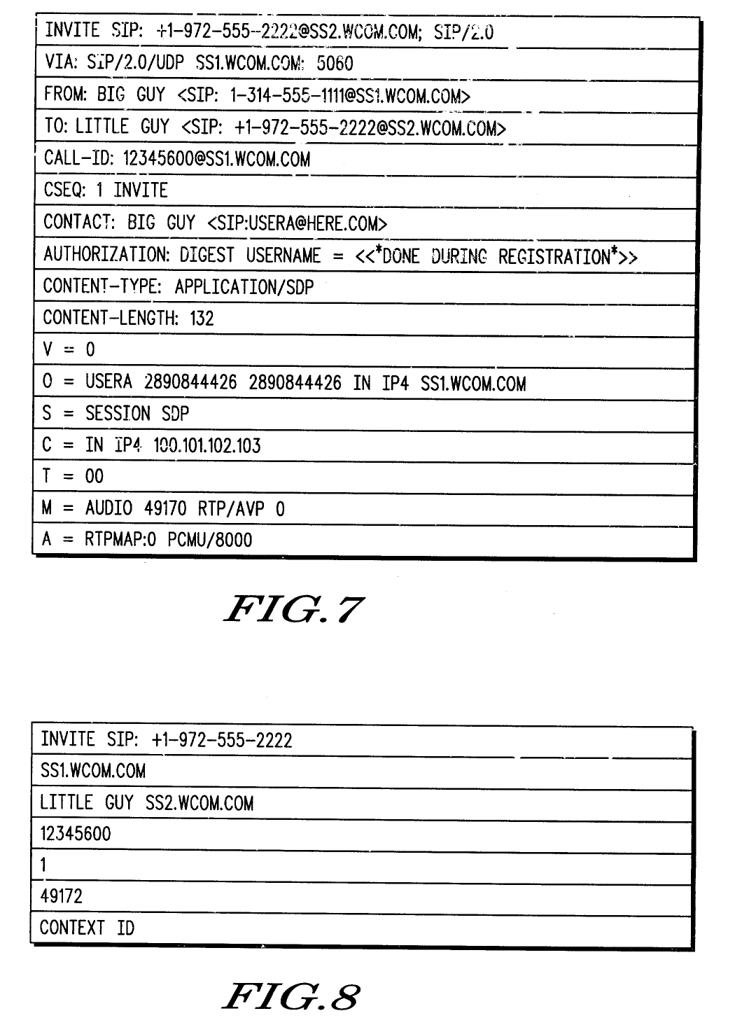

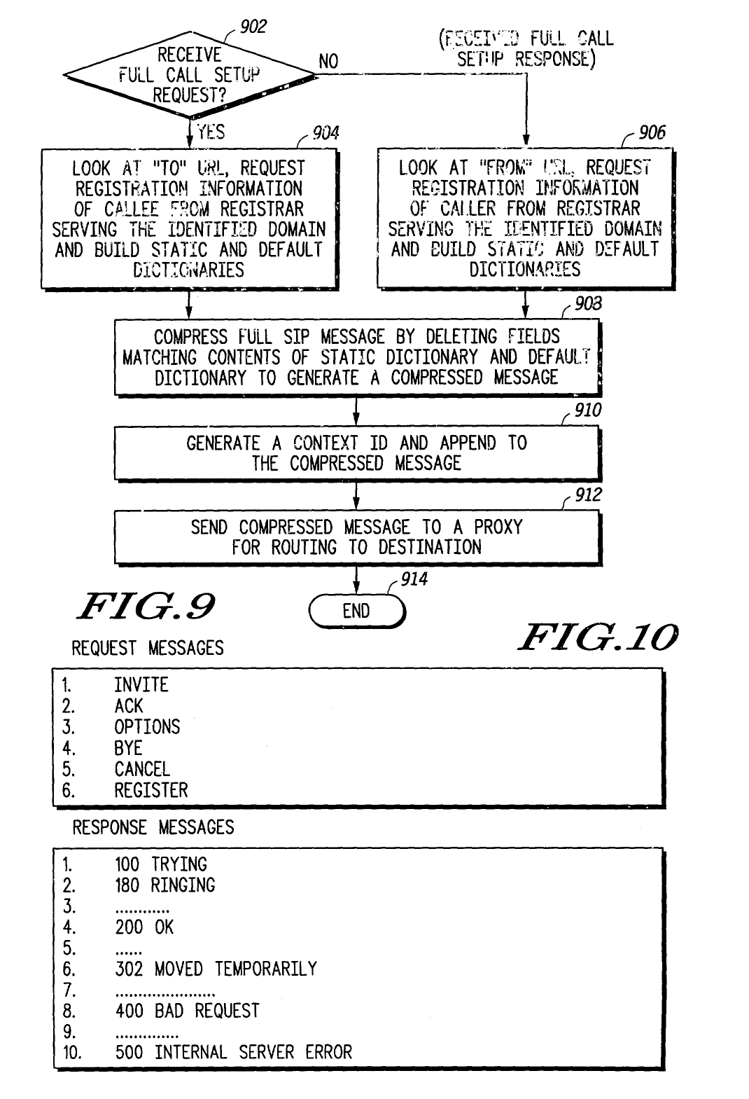

As illustrated in FIG. 2, the client issues a TCP/IP request for a Web page located on a Server A (S201). Following a handshaking period, Server A sends the HTML formatted document containing an embedded URL referencing the training program. The client then issues a TCP/IP request to Server B referenced by the embedded URL to obtain the training program (S202). The client also makes any other TCP/IP requests (S203) necessary to obtain any other resources (such as images, video or sound) needed to fully render the Web Page (S204). Each of these resources is typically referenced by individual URLs embedded in the HTML document. These requests do not need to occur in any specific order and may reference resources located on any server. Likewise, the information requested may be received in any order.

In the preferred embodiment, the training program is provided to the client by a content generator servlet 100 running on Server B, which obtains data from the training content database 102. The training program that is downloaded is an executable program written in JAVA, a so-called JAVA applet, which runs on the client. It is downloaded to the client in the form of a Java archive (.JAR) file. The training program applet is a generic program that is independent of any specific training or simulation content.

Once the training program has been downloaded to the client, it is saved in RAM (S205), and then started (S206). Once started, the first action performed by the training program is a request for a security check (S207) from server B. Another program running on server B, the security servlet 104, then executes a security check to insure that the client is authorized to be running the requested training program. If the security servlet 104 finds that the client is not authorized to run the requested training program, then no additional content or resources would be sent to the client by server B. The security servlet 104 may also perform additional tasks at this time, for example checking the bandwidth limitations of the client and/or obtaining information about the browser and operating system running on the client.

Following the security check, a configuration file is requested by the training program (S208) which is then downloaded from the content generator servlet 100. The configuration file contains all the training or simulation-specific information required by the training program in order to run the simulation. It includes information on what types of simulations will be run (e.g., object rotation, slide show, image strips, etc.) as well as information on what user input is to be monitored and how often it is to be uploaded to the server. Some resources needed for the training program (e.g., image files) are not included in the configuration file, but the configuration file provides the necessary URL addresses for these additional required resources. In the next step (S209), those additional resources are requested and downloaded to the client.

At this point, the simulation (S210) and tracking (S211) portions of the training program can start. A simulated representation of a physical object is then displayed on the client computer, as determined by the configuration file. The user at this point can begin a specified training task involving the manipulation of that simulated object. All user input, as specified by the configuration file, will now be monitored and stored temporarily on the client. The configuration file specifies what types of user input will be monitored—for example it may specify that literally all mouse and keyboard input be captured and stored, or it may specify that only mouse click locations be captured. What information is to be captured is predetermined on a case-by-case basis for each training program or simulation. At predetermined time intervals, also specified by the configuration file, the tracked user input is sent to the tracking servlet 106 that is running on the server (S212). This tracked input is stored in the tracking data/user transcript file database 108.

The information in the transcript file database 108 can be used for a number of different purposes. For example, it can be used to provide feedback to the user on his/her performance in manipulating the simulated object, it can be used by a course teacher or administrator to assess the performance of each user, it can be used by the course designer to refine the actual content of a particular training session, or it can be used to generate new, adaptive content for the user. This latter step is optionally accomplished in the update content step (S213).

The update content step (S213) is driven by the adaptive content generator servlet 110 that analyzes data from the transcript file database 108 to determine if new content is needed for the user based on his/her performance in completing a particular task. If it is determined that new content is needed, the adaptive content generator servlet 110 will fetch the necessary data from the training content database and feed it to the training program.

There are two types of training sessions that are provided by the training program. First, there are training sessions where the user is learning to manipulate the object simulated by the training program. During these sessions the user could learn and practice the task at hand, and may or may not be provided with feedback based on analysis of the tracked data performed at the server. He or she would typically not be assessed or “graded” during these practice sessions. The other type of session is one where the user's ability to manipulate the simulated object is specifically being assessed to validate comprehension of the task. In these sessions, the user is typically not provided with feedback during the test, but rather the server captures the user's input for assessment purposes.

The preferred embodiment of this invention utilizes the JAVA programming language. Executable programs written in JAVA, called applets, can be downloaded and run on a JAVA-enabled Web browser on the client computer to provide the functionality needed for the present invention. However, those of ordinary skill in the art will appreciate that the present invention can be implemented using programming environments other than JAVA. On the Internet, for example, the present invention has also been implemented in the so-called “Flash” environment, in which the tracking program is written as a Flash component.

Although the invention has been described in terms of the preferred embodiment, various modifications of the invention can be practiced within the spirit and scope of the appended claims. For example, the program used to transfer data could be a dedicated server or a direct connection to the database, rather than a servlet.

It should also be appreciated that while the preferred embodiment of the training program uses multiple databases for storing information, a single database could be used to store and process the information instead.

In the preferred embodiment of the training program, the server that downloads the training program and the associated configuration files to the client and the server that contains the transcript file database are one in the same. This is not a requirement of the present invention. The transcript file database may instead reside on a server other than the one that serves the training program. Similarly, while in the preferred embodiment the server that originates the network resource, or Web page (Server A), and the server that originates the training program (Server B) are different servers, this is also not a requirement of the present invention. The network resource (Web page) and the training program may be served out by the same server.

While in the preferred embodiments the training program uses the HTTP and TCP/IP protocols, other network data transmission protocols could be used that implement the same functionality. Likewise, the use of an HTML formatted Web page is not necessary. The information supplied to the user may not be in the form of an HTML or Web document, but can be information presented in some other format. Furthermore, the training program need not be downloaded to the client from the server, but can be a plug-in module in the client application or Web browser running on the client or it could be a cached resource stored elsewhere on the client computer. In such cases, the client application or Web browser would include appropriate means to enable activation of the training program and the uploading of a users performance based upon the user's interaction with the training simulation.

While the preferred embodiment has been described in the context of Web browser software, the techniques of the invention apply equally to all types of computer networks, including local area networks, wide area networks, public networks, private networks, the Internet, the World Wide Web, or the like, and whether access to the network is achieved using a direct connection or an indirect connection. In connection with the World Wide Web, the teachings herein apply whether a network connection is obtained with a direct Internet connection or indirectly through some on-line service provider. Thus, the “computer network” in which the invention is implemented should be broadly interpreted to include any computer network in which one or more clients is connectable to one or more servers, including those networks based upon the client-server model in which a client can link to a “remote” document (even if that document is available on the same machine, system, or “Intranet”).

Finally, it should also be understood that while in the preferred embodiment the training program is downloaded with the web page from the server, this is not a limitation of the invention. The training program may be embedded within a web browser or supported elsewhere within the client itself rather than being embedded within an existing Web page.. Thus, the training program may be initiated whenever a call to a web page or network resource is made, such as when a search to a particular URL is initiated, or when a previously-stored URL is launched.

What we claim is:

1. In a computer network having one or more servers connectable to one or more clients, a method of providing training to a user, comprising the steps of:
using a client to specify an address of an executable program located on a server, said executable program including a simulation of a physical object that can be manipulated by said user, said executable program also including a monitoring capability for monitoring said user's inputs to said client;
downloading said executable program from said server to run on said client so as to allow said user to interact with said simulated object,
using said executable to monitor said user interactions with said client;
uploading said user interaction data from said client to said server;
storing said interaction data on said server.
